(19) United States
(12) Patent Application Publication
(10) Pub. No.: US 2010/0257674 A1
(43) Pub. Date: Oct. 14, 2010

(54) Method for positioning a human subject for radiological imaging, surgery or minimally invasive procedures using an inflatable contoured pillow

(76) Inventors: Douglas Beall, Oklahoma City, OK (US); Patric Green, Shawnee, OK (US); Carla Green, Shawnee, OK (US)

Correspondence Address: BELL & ASSOCIATES, 58 West Portal Avenue No. 121, SAN FRANCISCO, CA, 94127, US

(21) Appl. No.: 12/758,067

(22) Filed: Apr. 12, 2010

Related U.S. Application Data
(60) Provisional application No. 61/212,663, filed on Apr. 13, 2009.

(51) Int. Cl. A61G 7/065

(52) U.S. Cl. 5/630

(57) ABSTRACT

An ergonomic pillow for supporting and positioning a human subject on an imaging table having one or more inflatable chambers, and methods of use.

Relationship to other applications: This is a non-provisional application that claims priority to and the benefit of U.S. provisional application No. 61\212663 filed 13 Apr. 2009 to the same inventors, titled “A method for positioning a human subject for radiological imaging, surgery or minimally invasive procedures using an inflatable contoured pillow”

Government sponsorship: None

### FIELD OF THE INVENTION

The invention relates to a method for positioning a human subject for radiological imaging, surgery, or minimally invasive procedures using an inflatable and contoured pillow that is designed to allow the proper positioning of a human subject on a table during surgery or radiological and other types of medical imaging so as to allow optimum respiration, patient protection, comfort and proper imaging. The invention is of particular use when the patient in required to lie in a face-down prone position with arms raised above the head.

### BACKGROUND

A number of supports and structures and tables are known for positioning a patient for surgery or for radiological imaging. None of these devices, however, provide the features, objects or advantages of the present invention.

### BRIEF DESCRIPTION OF THE INVENTION

The invention encompasses a method for positioning a human subject for radiological imaging, surgery or minimally invasive procedures using an inflatable radiology pillow and particularly to a pillow designed to allow the proper positioning of a subject on a table during radiological imaging and/or surgical procedures. The invention is of particular use when the patient in required to lie in a face-down, prone position with arms raised above the head.

The invention encompasses a number of embodiments including a method for imaging a human subject, the method comprising: providing an imaging table, providing a subject, providing an ergonomic pillow, and positioning the ergonomic pillow between the table and the subject so as to provide desired support and positioning for imaging and capturing an image of the subject and for performing surgery or minimally invasive procedures; the ergonomic pillow being horseshoe shaped, is substantially made of a material that is not opaque to x-rays or ultrasound, is designed and sized to be placed under a patient's chest and axilla when the patient is lying chest-down on a surface, the pillow comprising an inflatable bladder with one or more inflatable chambers; the method comprising visually examining the subject, positioning the subject on the table, inflating the ergonomic pillow to a first inflation state, placing the ergonomic pillow under the subject, optionally inflating the ergonomic pillow to a second inflation state so as to provide desired support and positioning, and capturing an image of the subject or performing the necessary invasive procedure. The pillow may comprise at least two inflatable chambers and may further comprise an inflation means in functional communication with one or more of the inflatable chambers and/or one or more a pressure gauge(s) in functional communication with one or more of the inflatable chambers. The invention also include a device such as an ergonomic pillow for supporting and positioning a human subject on an imaging table, the ergonomic pillow being substantially made of a material that is not opaque to x-rays or ultrasound, and being horseshoe shaped, designed and sized to be placed under a patient's chest and axilla when the patient is lying chest-down on a surface, the pillow comprising an inflatable bladder with one or more inflatable chambers. The pillow may have two or more separate inflatable chambers and/or two or more separate inflation means individually in communication with two or more of the inflatable chambers.

### BRIEF DESCRIPTION OF THE DRAWINGS

Key.

1=bulb pump

2=pressure gauge

3=pressure tubing

4=body of pillow

5=head rest

6=first chamber

7=second chamber

8=electronic pump

FIG. 1A, B and C show schematic views of the invention from the top, front and side aspects, respectively.

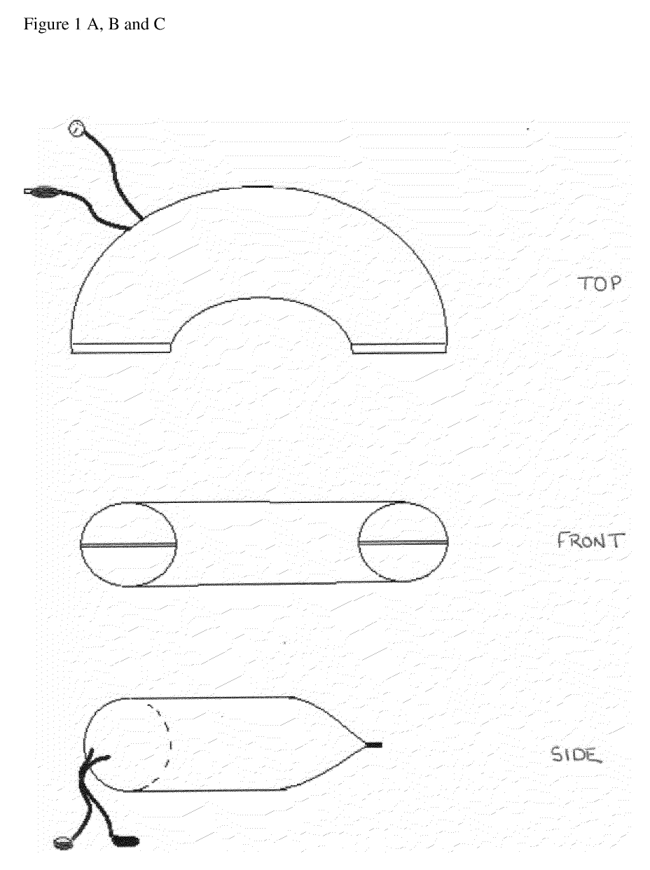

FIG. 2 shows a top view of the pillow in use with a with a subject lying chest-down upon the pillow.

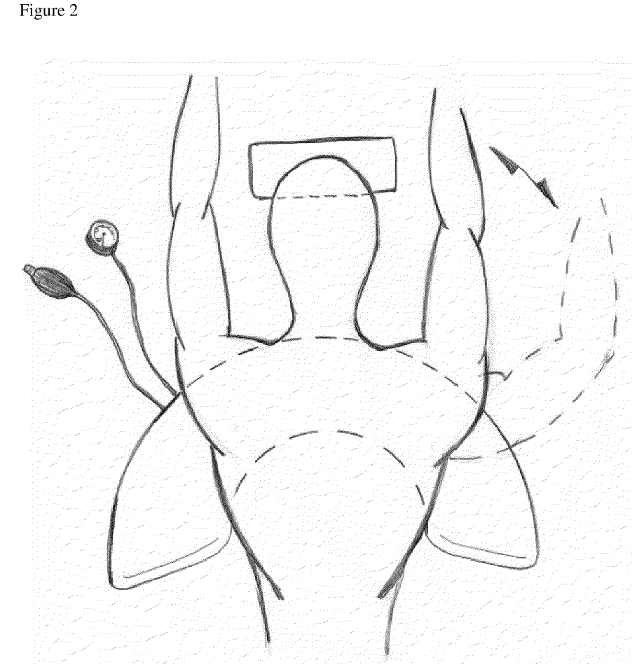

FIG. 3 shows a side view of the pillow in use with a with a subject lying chest-down upon the pillow.

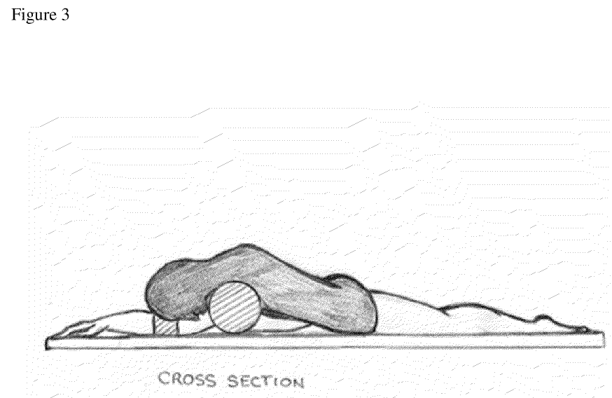

FIG. 4 shows an isometric view of the pillow when inflated showing the bulb pump and the pressure gage attached to the body of the pillow.

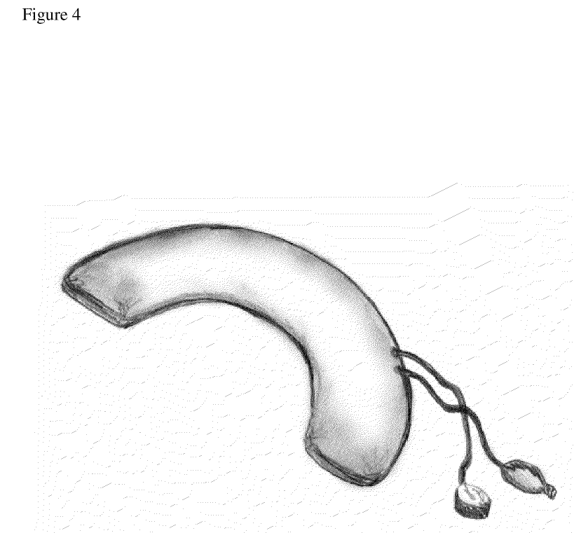

### DETAILED DESCRIPTION OF THE INVENTION

Definitions: The following words are defined as follows in the application.

“Pillow” means any three dimensional support including an inflatable support comprising one or more inflatable bladders, the term is not restricted to any particular shape or size.

“Table” means any form of support with an approximately flat horizontal surface.

“Imaging” refers to the process of capturing an image.

“Minimally invasive procedures” refers to percutaneous procedures or other procedures with small incisions or punctures that are used to access to the internal components of the body.

“Horse-shoe shaped” in this application means shaped roughly in the form of a crescent with both ends of a elongated three dimensional polygon bending in approximately the same direction in the same plane; such a shape may be curved to any degree such that it's total radius of curvature (the total curvature from one end of the object to the other) is at least 20 degrees, preferably 40 degrees, or 180 degrees or in some cases, more. The ends may bend inwards or outwards in various embodiments. In other embodiments the pillow may be elongated and curved but with the ends curving in different directions. The shape of the pillow and the ability to inflate and deflate the pillow when in use is particularly important for the function of the pillow allowing it to accommodate various anatomies during different imaging procedures.

“Capturing” (an image) means producing a lasting image using chemical or electronic means.

“Inflation state” (as in a first inflation state and a second inflation state) refers to the state of shape of the pillow of the device when inflated or partially inflated.

“Contoured” means shaped, particularly shaped to fit in a complimentary way with the shape of the body of a subject. A contoured pillow will generally not be a simple rectangular shape no a simple polygon shape, but will be moulded and adapted to fit with the body parts of a subject.

General Representations Concerning the Disclosure: In this specification, reference is made to particular features of the invention (including for example components, elements, devices, apparatus, systems, groups, ranges, method steps, test results, etc). It is to be understood that the disclosure of the invention in this specification includes all appropriate combinations of such particular features. For example, where a particular feature is disclosed in the context of a particular embodiment or a particular claim, that feature can also be used, to the extent appropriate, in the context of other particular embodiments and claims, and in the invention generally. The embodiments disclosed in this specification are exemplary and do not limit the invention. Other embodiments can be utilized and changes can be made. As used in this specification, the singular forms “a”, “an”, and “the” include plural reference unless the context clearly dictates otherwise. Thus, for example, a reference to “a part” includes a plurality of such parts, and so forth. The term “comprises” and grammatical equivalents thereof are used in this specification to mean that, in addition to the features specifically identified, other features are optionally present. For example, a device “ comprising” (or “which comprises”) elements A, B and C can contain only elements A, B and C, or can contain not only elements A, B and C but also one or more other elements. The term “consisting essentially of and grammatical equivalents thereof is used herein to mean that, in addition to the features specifically identified, other features may be present which do not materially alter the claimed invention. The term at least” followed by a number is used herein to denote the start of a range beginning with that number. Where reference is made in this specification to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps (except where the context excludes that possibility). Where reference is made herein to “first” and “second” features, this is generally done for identification purposes; unless the context requires otherwise, the first and second features can be the same or different, and reference to a first feature does not mean that a second feature is necessarily present (though it may be present). Numbers given herein should be construed with the latitude appropriate to their context and expression; for example, each number is subject to variation which depends on the accuracy with which it can be measured by methods conventionally used by those skilled in the art. This specification incorporates by reference all documents referred to herein and all documents filed concurrently with this specification or filed previously in connection with this application, including but not limited to such documents which are open to public inspection with this specification.

The invention encompasses a device, generally referred to as a pillow, which is designed to allow the proper positioning of a human subject on a surface such as a table during radiological and other types of medical imaging, surgery, and minimally invasive procedures. The invention is of particular use when the patient in required to lie in a face-down, prone position with arms raised above the head.

In one embodiment the invention comprises an inflatable horseshoe shaped pillow that is shaped and sized to be placed under a patient's chest and axilla when the patient is lying chest-down on a surface for imaging. The pillow may be inflated or deflated to adjust to the patient's comfort needs and to allow proper and desirable positioning of the patient. The inflation of the pillow may be adjusted prior to or during a procedure to allow repositioning during the procedure. The pillow may be adjusted before or during a procedure to suit an individual patient's size, shape and mobility. The pillow is generally shaped roughly in the form of a crescent or may be elongated and curved but with the ends curving in different directions.

Objects and Advantages

The invention addresses the problems caused by the pressure that is inevitably placed on the chest and abdomen (particularly including the lungs and diaphragm) of a patient wherein the pressure is created by the patient's own weight during procedures that are performed in the chest-down prone position either with no sedation or often with moderate to deep sedation. The prone position alone compromises respiration by compressing the thorax and restricting its normal outward excursion. It further compromises respirations by causing compression of the abdomen, forcing the abdominal viscera up into the diaphragm, limiting diaphragmatic excursion. The prone position itself also makes patient airway access more difficult as the patient is face down on the table. The addition of sedative medications may further compromise the patient's respiratory wellbeing. The weight of the patient's body, especially in the case of an obese patient, further adds to the problem making breathing difficult.

Unlike certain prior solutions, the current device is not fixed to a table but may be easily moved on the table, under the patient or from one positioning table to another. The present invention does not, in various embodiments, include straps, clips or other fastening devices or elements. The present invention is not large and is not designed to encompass the whole body and is not fixed to the body but may be moved or substantially adjusted at any time to meet changing patient needs.

The present invention may be horseshoe shapes so that it can be adjusted on the sides for the size and shape of the patient.

Indication

Breathing: With sedation or anaesthesia this becomes a problem because of the decrease in the respiratory effort that is created by the sedative medication. The higher the dose of sedative the more reduced the respiratory effort. This combined with the weight of the patient's body applied to and transmitted to the chest wall can compromise the patient's ability to maintain effective breathing. This is a normal physiological change that occurs in the prone chest-down position that is increased with the effects of sedative medication.

Comfort: A typical population undergoing imaging may be elderly. In such a case it has been found that it is very helpful to position patients for enhanced comfort. Many patients are kyphotic and do not have the flexibility to place their arms above their heads while in the prone position without support in the axillary area of the body.

Many subjects who require radiological or other medical imaging have shoulder injuries that necessitate surgery and they are also not easily capable of lying down in a prone position with their arms above their head. For the elderly patient as well as the obese patient, lying prone may be a challenge in itself. The present invention addresses these needs.

Another advantage of this positioning device is the benefit it provides for a woman lying in a prone position while on a hard surface. With the female anatomy the horseshoe shaped pillow relieves the pressure and discomfort on the breasts, especially if they are very large and ungainly.

The pillow may be made from a single bladder that may be filled with a fluid such as air. Generally air is used to inflate the bladder or bladders of the pillow, but in alternative embodiments the fluid may be a liquid or a gel.

Inflation of the bladder(s) may be done using a simple hand-operated bulb-type pump with a valve such as those commonly uses with a sphygmomanometer. Alternatively an electric pump may be used. The bladder may even be inflated by blowing into a tube attached to the bladder.

The pillow may be made from a plurality of separate bladders joined together to form a single pillow. The bladders may be functionally connected so that air blown into a single air input will flow from one bladder to the other filling the bladders and inflating the pillow. Alternatively the bladders of the pillow may be separated and not interconnected so that each bladder or each group of bladders is separated from the other bladders. In this case the bladders may be inflated individually or in connected groups to provide the desired support.

The bladder or bladders may be filled with and inflated with air or any other fluid, either liquid or gas. The fluid may preferably be air, pumped into the bladder or bladders by means of a hand pump or an electric pump. Alternatively the fluid may be a liquid such as water or a gel, which may optionally be heated to provide desired support and comfort.

Materials used to make the body of the device are generally not radio opaque, as that would prevent accurate radiological imaging. Any non radio opaque material may be used such as rubber or plastic or any variety of polymers such as polyester, polystyrene, PVC, PDTA etc. Materials should generally be transparent to all imaging energies such as X-rays or ultrasound, neutrons, protons and imaging energies used by NMR (MRI) and PET scanners.

The Shape of the device (pillow) may be horse-shoe shaped, rectangular, square, conical, spherical, tubular or any other suitable shape. Generally the pillow will be contoured and will include one or more hollows, voids or indentations to accommodate various parts of the anatomy of a subject and allow comfortable positioning. In various embodiments the pillow will specifically not be rectangular.

One or more of the pillows may be used simultaneously to position a subject. The size of the pillow may vary but the pillow will generally be sized somewhere between a normal sleeping pillow and an airline travel pillow, and will generally have a maximum dimension of about one meter or as little as 300 cm.

Support for the head may be provided by a separate pillow or by a part integrated into the pillow such as a concave or convex shaped part. For example, in order to facilitate easy breathing in the chest-down position, the pillow may include a head rest defined by a horse-shoe shaped or torroidal or round indentation so that the subject can lay his or hear head into the indentation, with the forehead in contact with the pillow, but with the mouth and nose free of obstruction (similar to the attachment on a massage table). Such a structure allows easy breathing and provides and reduces the sense of confinement that could otherwise lead to a feeling of panic for the subject.

Support for chest, and axilla are inherently provided by the body of the pillow placed under the subject.

For babies or infants the pillow may be shaped and sized accordingly to conform to the smaller anatomy of those individuals. Likewise, for the obese subject, for a woman, for women with various sized breasts, for a man, or for any other body shape.

The device may optionally be fitted with a pressure monitor that allows the operator to inflate the pillow to a specific per-determined pressure.

The device may be further provided with other features such as a surface suitable for the retention of a scent, such as an absorbent area onto which a calming scent, such as lavender may be placed. In another alternative embodiment the pillow may be fitted with speakers to allow music or instructions to be conveyed, or with a microphone to allow communication between the subject and the operator who may be behind a radio-protective screen or wall. In other alternative embodiments, the device may include various colours, textures etc to provide aesthetic and or comfort advantages.

The invention also includes a method for positioning a subject by placing the subject on a table (a surface) and placing one or more of the devices (pillows) underneath the subject. The subject may be placed in a face-down, prone position with arms raised above the head. The pillows may be pre-inflated to the desired degree of inflation, of may be inflated after they are positioned under the subject.

### EXAMPLES

Examples of various embodiments are shown in the figures and described in the specification, above.

1. A method for imaging and/or positioning human subject, the method comprising: providing an imaging table, providing a subject, providing an ergonomic pillow, and positioning the ergonomic pillow between the table and the subject so as to provide desired support and positioning for surgery, minimally invasive procedures, imaging and capturing an image of the subject; wherein the ergonomic pillow is horseshoe shaped, is substantially made of a material that is not opaque to x-rays or ultrasound, is designed and sized to be placed under a patient's chest and axilla when the patient is lying chest-down on a surface, the pillow comprising an inflatable bladder with one or more inflatable chambers; the method comprising visually examining the subject, positioning the subject on the table, inflating the ergonomic pillow to a first inflation state, placing the ergonomic pillow under the subject, optionally inflating the ergonomic pillow to a second inflation state so as to provide desired support and positioning, and capturing an image of the subject.

2. The method of claim 1 wherein the pillow comprises at least two inflatable chambers.

3. The method of claim 2 wherein the pillow further comprises an inflation means in functional communication with one or more of the inflatable chambers.

4. The method of claim 3 wherein the pillow comprises a pressure gauge in functional communication with one or more of the inflatable chambers.

5. The method of claim 2 wherein the pillow further comprises two or more separate inflation means individually in communication with two or more of the inflatable chambers.

6. The method of claim 2 wherein the position of the subject is checked before and after inflating the ergonomic pillow to a second inflation state.

7. The method of claim 2 wherein the position of the state of inflation of the pillow is controllable by the subject.

8. An ergonomic pillow for supporting and positioning a human subject on an imaging table, the ergonomic pillow being substantially made of a material that is not opaque to x-rays or ultrasound, and being horseshoe shaped, designed and sized to be placed under a patient's chest and axilla when the patient is lying chest-down on a surface, the pillow comprising an inflatable bladder with one or more inflatable chambers.

9. The ergonomic pillow of claim 8 further comprising two or more separate inflatable chambers.

10. The ergonomic pillow of claim 9 further comprising two or more separate inflation means individually in communication with two or more of the inflatable chambers.

11. The ergonomic pillow of claim 9 wherein the inflation means are manual bulb-type pumps.

12. The ergonomic pillow of claim 9 wherein the inflation means are electronic pumps.
